(19) United States
(12) Patent Application Publication
(10) Pub. No.: US 2014/0290456 A1
(43) Pub. Date: Oct. 2, 2014

(54) TWO-SAW ASSEMBLY HIGH-SPEED PRODUCTION CHOP-SAW

(71) Applicant: HASKO, INC., Soddy Daisy, TN (US)

(72) Inventor: Louis R. Brooks, Signal Mountain, TN (US)

(21) Appl. No.: 14/215,881

(22) Filed: Mar. 17, 2014

Related U.S. Application Data
(60) Provisional application No. 61/791,778, filed on Mar. 15, 2013.

(51) Int. Cl. B26D 5/30; B26D 7/18; B27B 31/00

(52) U.S. Cl. CPC B26D 5/30; B27B 31/00; B26D 7/1854
USPC 83/98; 83/370; 83/165

(57) ABSTRACT

An assembly for detecting proscribed defects in lumber having a first and second chop saw that operate independently and simultaneously to cut the defected areas of lumber from a piece of lumber and dispense the defected lumber pieces from a housing containing the assembly.

### CROSS-REFERENCE TO PRIORITY APPLICATIONS

This application claims the benefit of and priority to U.S. Provisional Patent Application Ser. No. 61/791,778, filed Mar. 15, 2013, in the U.S. Patent and Trademark Office. This application incorporates the earlier provisional application by reference in its entirety.

### BACKGROUND OF THE INVENTION

The present invention relates generally to automatic chop saws and more specifically it relates to an assembly for detecting proscribed defects in lumber having a first and second chop saw that operate independently and simultaneously to cut the defected areas of lumber from a piece of lumber and dispense defected lumber pieces from a housing containing the assembly.

### SUMMARY OF THE INVENTION

The invention comprises in one embodiment an assembly designed to operate as part of an integrated system in conjunction with an upstream board scanning or marking system for the purpose of detecting and/or cut to length and/or grade optimization of lineal boards and strips.

The assembly incorporates two independent fixed saws that are positioned in one embodiment approximately 36 inches apart. The two saws work independently via a servo drive stroke actuator so that cuts and feed of lumber material can be made simultaneously or concurrently with other machine functions.

The assembly includes three feed sections, namely an in-feed Section, a middle feed or waste removal section and an out-feed Section. Each section provides servo driven feed rolls designed to operate independently and synchronously with each other. Thus for example, the feed rolls in the middle feed section can advance a strip to its next cut point at the second saw while another strip is being moved into positioned or being cut at the first saw. Waste up to 36″ long is ejected in the middle feed section onto an integrated waste belt. As a result of the unique two saw design, the assembly is potentially is 15%-40% more productive than conventional single blade automatic chop saws.

The production characteristic is a major advantage in high volume applications such as hardwood flooring or dimension manufacturing where it is common to process 40,000 board feet to 60,000 board feet per shift. In these operations the added productivity can potentially negate the need for a second or third chop saw line. The elimination of one additional chop saw line can potentially save the user $400,000 to $600,000 per line in capital cost, reduce labor requirements, reduce energy costs by thousands of dollars annually and reduce floor space required by additional chop saw lines in production facilities.

One object is to provide a chop saw assembly that utilizes the data output of an automatic defect-scanning device for an uninterrupted, continuous operation for lumber defecting.

Another object is to provide a chop saw assembly that increases defecting thru put by 20%.

Yet another object is to provide a chop saw assembly that provides a convenient and trouble free waste removal process.

The dual saw assembly replaces the traditional single saw thereby enabling an increased thru put rate of approximately 20%. A blade stroke arm activates the saw on signal from scanner data. The stroke arm lowers the saw blade assembly to make the required cut. A blade spindle assembly consists of saw blade bearings and housings, an idler pulley, a motor, a saw blade, a servo motor, and a gear box. The blade spindle assembly is a complete unit that makes up both the first and second saw assemblies.

Scanner information provides automatic positioning of material (e.g., lumber piece) being processed. As each piece is scanned for defects, the resulting information positions the piece for sawing. The twin saw concept of this invention can also be used when manually marking defects but with significantly lower thru put rates.

The saw assembly is made up of the following elements: stroke servo motor and gear box (i.e., servo motor and associated parts provide the stroke action of the saw assembly). The servo motor is activated upon receiving data from the scanner. The saw drive motor and stroke servo motor support function to provide the required heavy duty impact resistant parts.

This invention embodies a unique waste removal process in that the waste is always confined to the area between the saw blade assemblies thereby facilitating fast and efficient waste removal (e.g., the elimination of material such as knots, wanes, and splits). The board is positioned by the data received from the scanner at the right side of the defect being removed.

The assembly is designed to receive defect positional information from a defect scanner. Based on the scanned defect locations, the two saw assemblies may work independently, simultaneously or at any time required. Each section has a set of feed rolls that are also designed to operate independently and synchronously. Thus, the feed rolls in the middle waste removal section can be moving a strip to its next cut point at the second saw assembly while another strip is being moved into position or being cut at the first saw assembly. Also, the first saw assembly may be cutting while the out fee rolls are moving a strip to the exit conveyor.

In one embodiment, the minimum board strip length is 4 feet and the minimum board strip length (after a defect is removed) is 13 inches long. Board strips longer than 36 inches that are classified as waste must be cut or discharged after exiting the chop saw.

A first sensor (located at the board strip entrance of the assembly) detects the incoming board strips. No board strip in the machine equals all feed rolls off and all hold down rolls are up. Once detected, the board strip position is linked to encoder data (from servo motors that drive the feed rolls) that is used for activating the hold down rolls. Whenever a board strip is positioned directly under a hold down roll, the roll is engaged and applies pressure to the top of the board strip. Each hold down roll remains in the down or engaged position as long as a board strip is under that particular roll. As the board strip passes, each roll will return to its up or disengaged position. It is important to note that the hold down rolls should never be engaged until the board strip is directly under the roll. Engaging a roll before a board strip is directly under the roll may stop the board strip and prevent it from passing through the machine. The hold down rolls are in the up position when a defect is being discharged to the waste conveyor.

It is important to note that two short board strips (e.g., one passing through which may or may not have a defect and one behind with a defect) may be in the waste removal section at the same time. In this case the hold down rolls that correspond to the board strip that is being passed through are in the down or engaged position while the hold down rolls that correspond to the board strip that has a defect should be in the up position.

When the start button has been pressed and an incoming board strip has been detected by the first sensor, all feed rolls run at that the feet/minute defined in the setup parameters. The in feed rolls continue running for about 30 seconds after the board strip has passed through the machine in an effort to keep product flow at maximum speed.

The second sensor (located between in feed hold down Rolls #2 and #3) is used to detect the leading edge of incoming board strip while being secured by hold down rolls. At this time cut point data (sent from a scanning system) is registered with the leading edge of each board strip.

As a secondary board strip registration check, the third sensor (located between hold down rolls #8 & #9) detects the leading edge of a board strip while moving to the second chop saw assembly. The board strip registration or board strip positional data is double checked by comparing it with the first board strip registration data. If there is a difference, the secondary board strip registration point is used.

The feed rolls that are moving the board strip with a defect are always stopped during chop saw cut cycles. The waste or defect reject begins as soon as the chop saw has started cutting the board strip. This provides sufficient time for the air blasting solenoids to energize and for the defect to be removed (i.e., ejected to the waste take-away conveyor) while the chop saw is completing the cut cycle.

It is possible for two shorter board strips (i.e., one at the first saw and one passing through to the next saw) to be in the waste removal section at the same time. Since there is no hold down roll next to the exit end of the first chop saw assembly, the middle feed rolls can continue to run (even though a board strip may be on a feed roll) while the first chop saw is cutting and its corresponding feed rolls are stopped.

Usually defects are removed in the middle section of the machine. A board strip with a single defect on the leading end (one cut point) is cut by the first chop saw assembly. A board strip with a single defect on the trailing end (one cut point) is cut by the second chop saw assembly. When a board strip with two defects (i.e., one on the leading end and one on the trailing end), the defect on the leading end is cut by the first chop saw assembly and the defect on the trailing end is cut by second chop saw assembly.

Another unique function is that each saw assembly can be programmed to work as a single chop saw. Thus, should either saw become disabled, the machine can continue run.

To maintain a constant flow of board strips, the two blade assembly requires a board strip feeder. The feeder is designed to deliver a lateral to linear transfer of board strip to a conveyor that feeds directly into the assembly. In order to have a fully synchronized system, an assembly controller is used to control all feeder functions.

The lateral section of the feeder allows the board strips to accumulate or creates a backlog that is used to sustain a constant flow of board strips. The lateral to linear transfer is accomplished with a pinch roll. The linear conveyer that feeds the assembly is servo controlled and is designed to speed up or slow down so that there is always a minimal amount of gap between each board. Because the leading edge of each board strip is used for registration, it is important that there is always a gap (e.g., 1-2 inches) between each board. Concurrently, in order to maintain maximum through put, the gap must be keep at its minimum. Thus, the linear conveyer must speed up when large gaps occur and slow down to prevent board strips from touching. It is important to note that a long board strip that has only one defect at the trailing end passes through the machine much faster than a board strip with multiple defects.

### BRIEF DESCRIPTION OF THE DRAWINGS

The foregoing and other objects and advantages of the invention and the manner in which the same are accomplished will become clearer based on the following detailed description taken in conjunction with the accompanying drawing in which various embodiments of the invention are depicted.

FIG. 1 is a cross-sectional front side view of one embodiment of the invention;

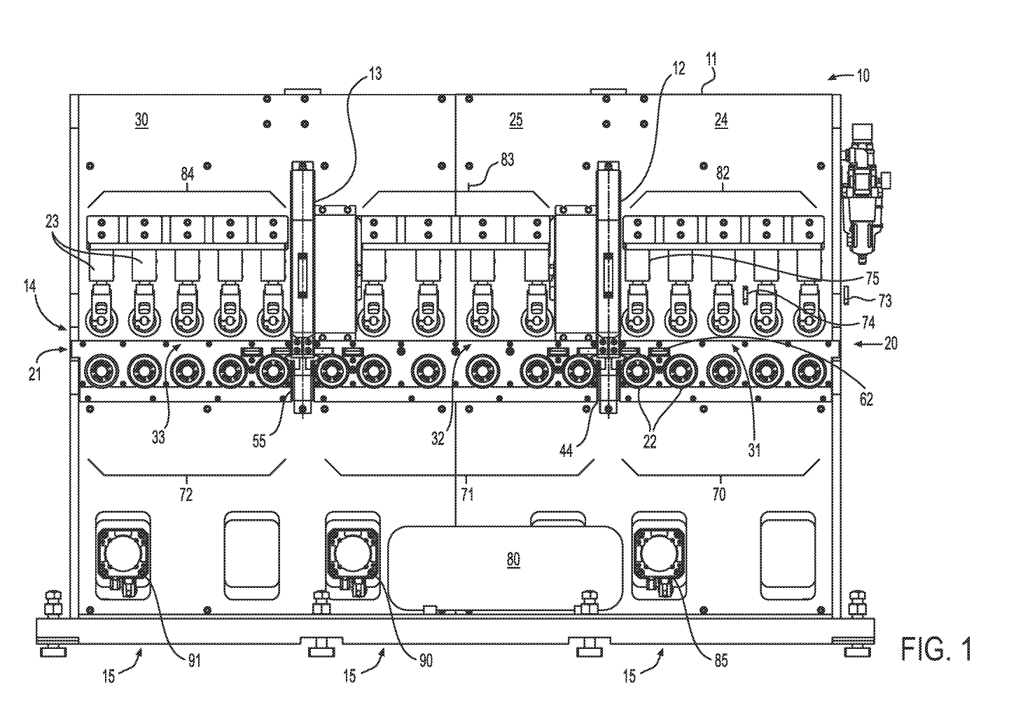

FIG. 2 is a perspective view of the invention depicted in FIG. 1;

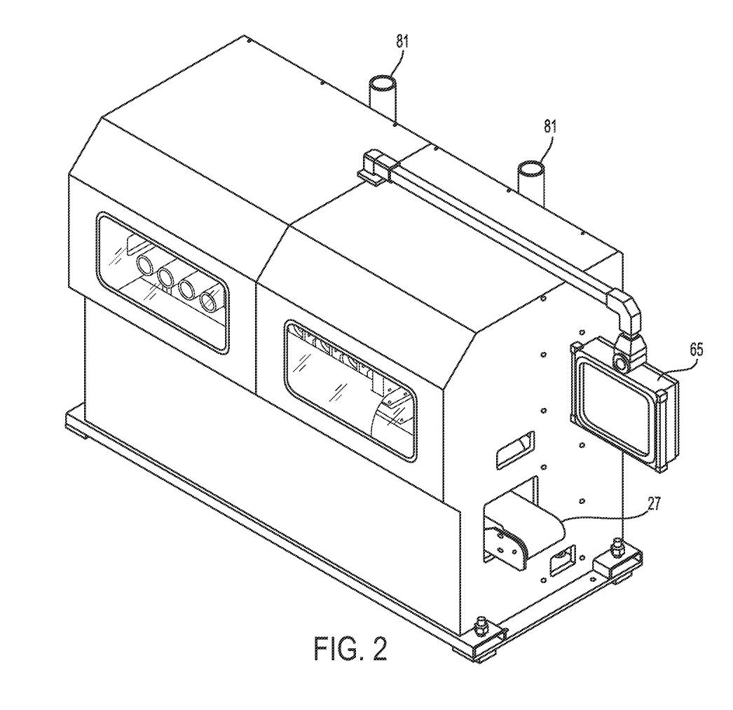

FIG. 3 is a front side view of the invention depicted in FIG. 1;

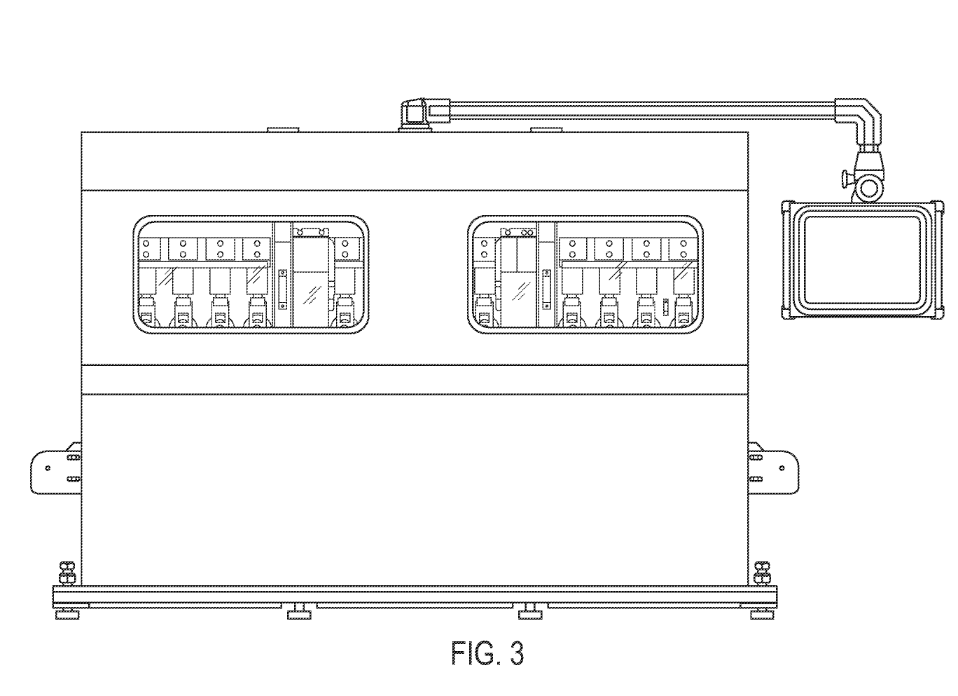

FIG. 4 is a back side view of the invention depicted in FIG. 1;

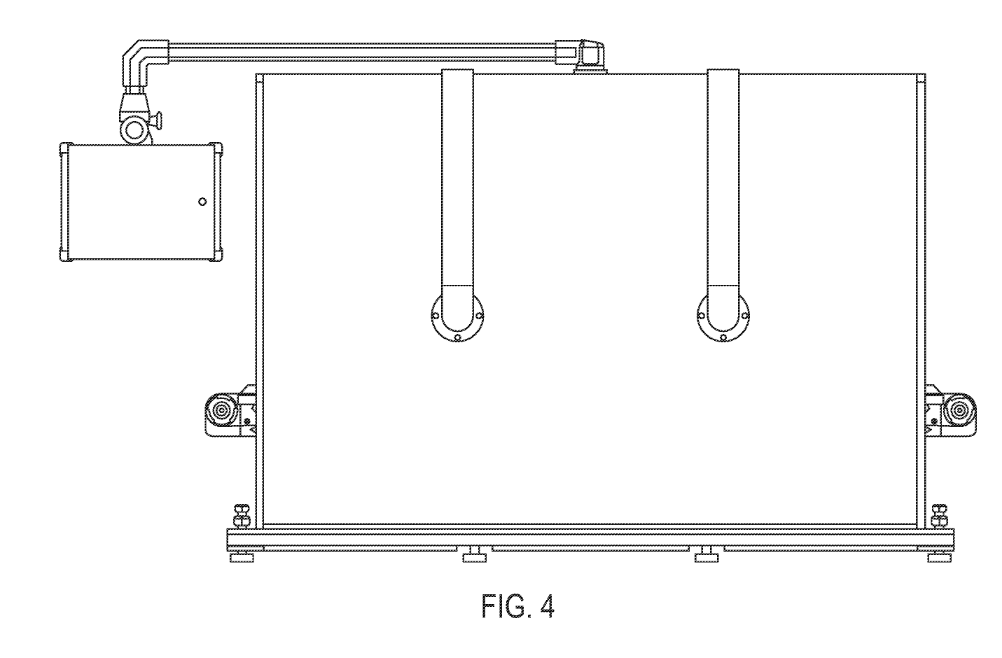

FIG. 5 is a right side view of the invention depicted in FIG. 1;

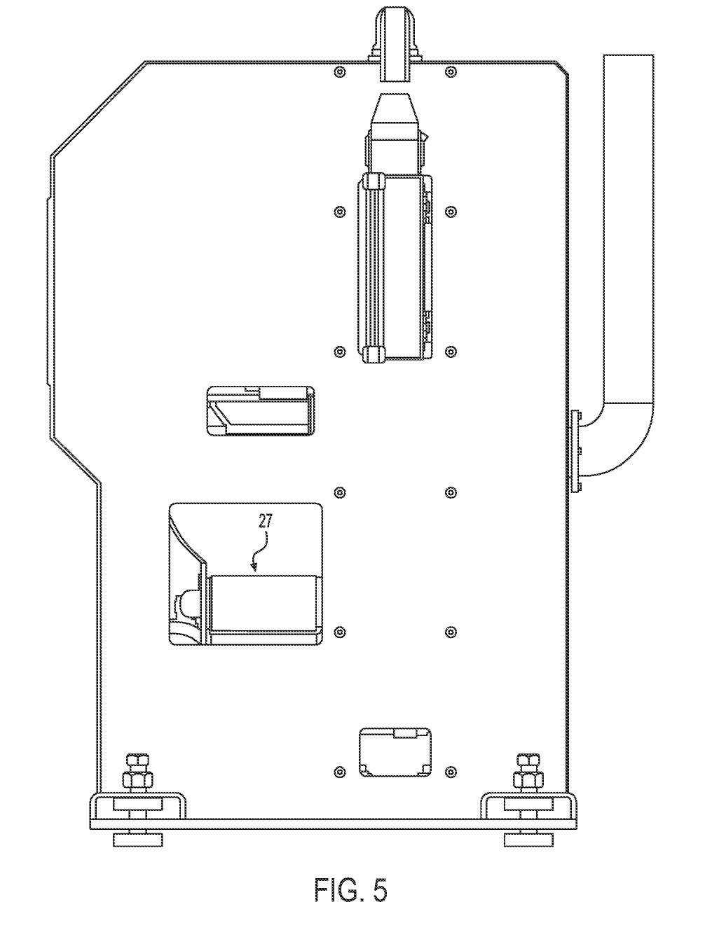

FIG. 6 is another perspective view of the invention depicted in FIG. 1;

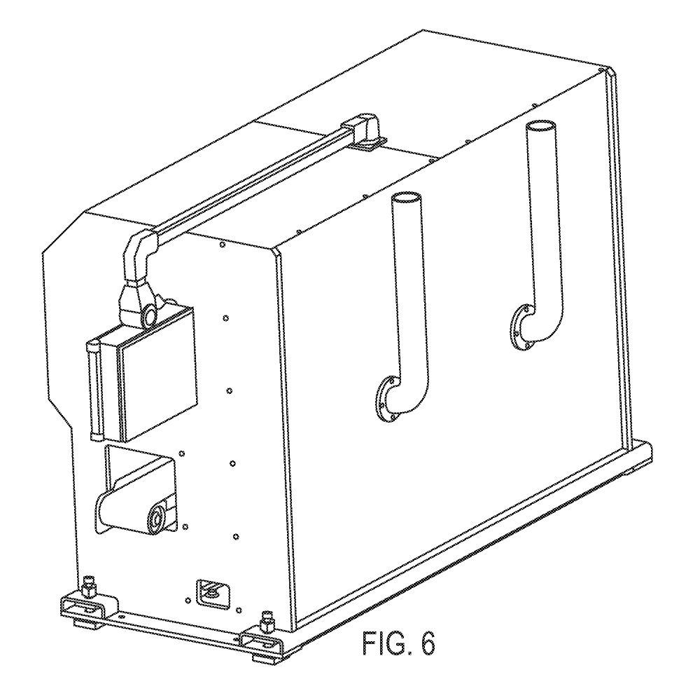

FIG. 7 is a partial perspective view of the invention depicted in FIG. 1;

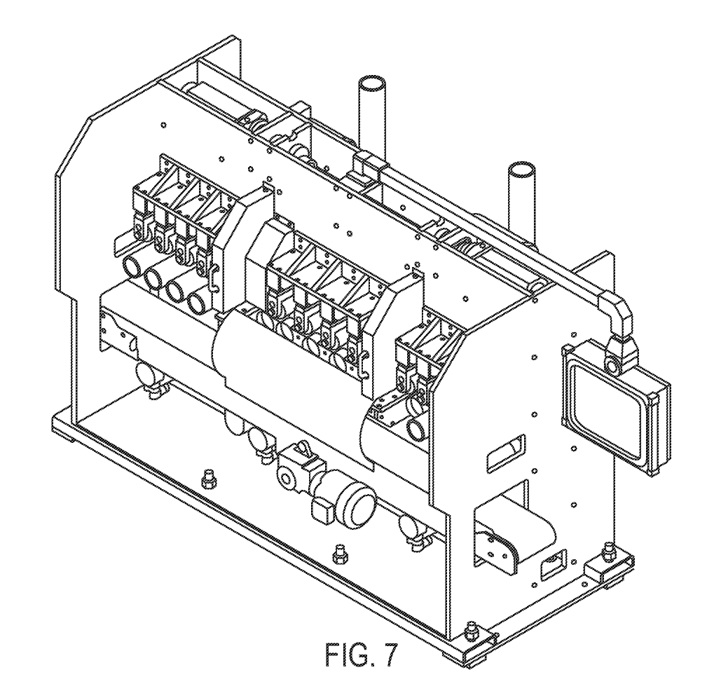

FIG. 8 is another cross-sectional front side view of the invention depicted in FIG. 1;

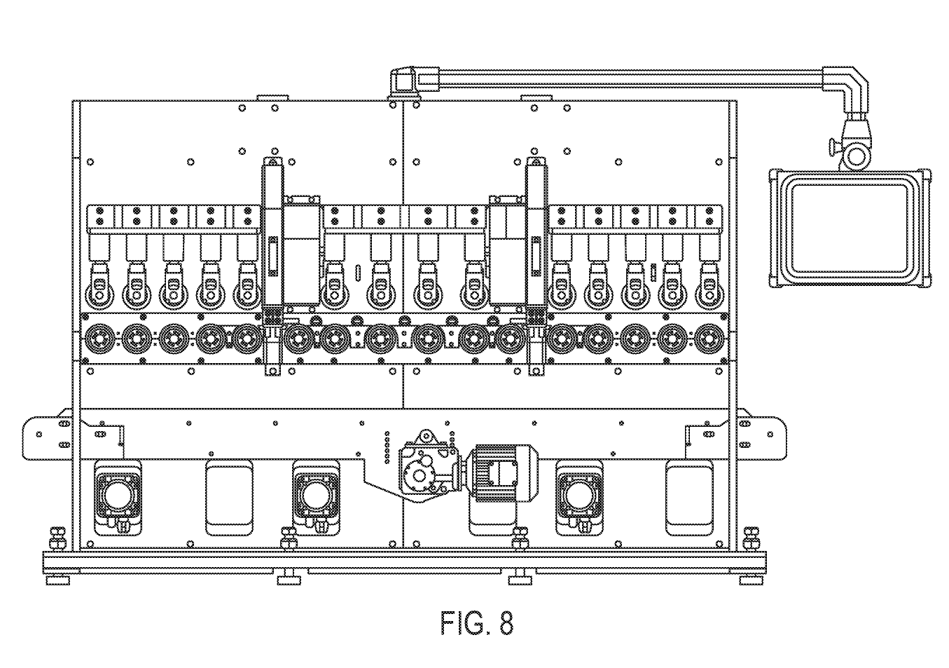

FIG. 9 is FIG. 8 is a cross-sectional back side view of the invention depicted in FIG. 1;

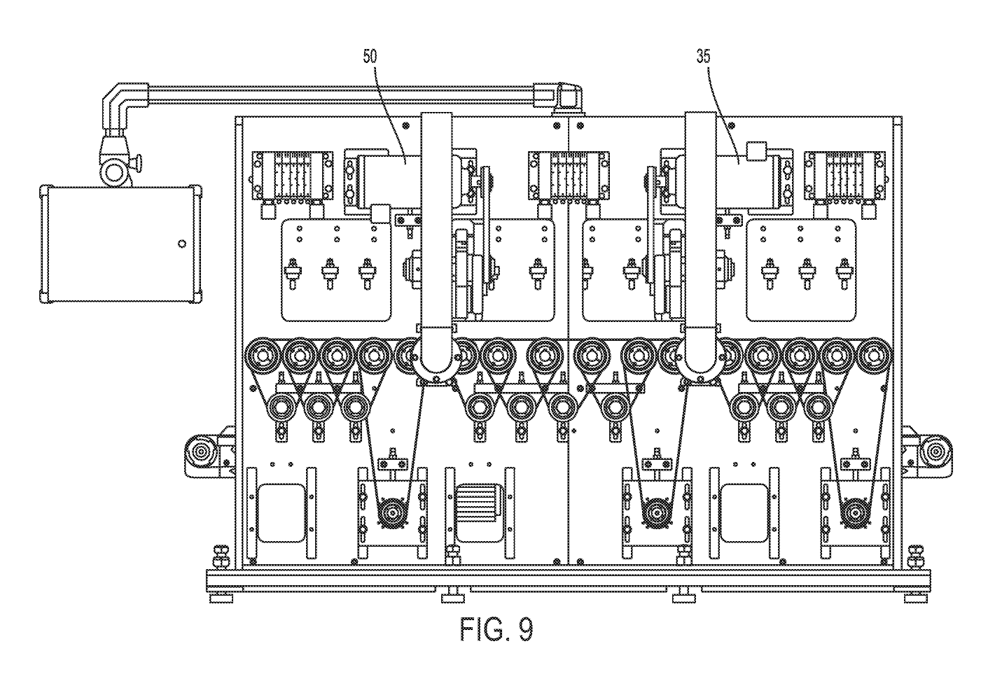

FIG. 10 is a side schematic view of one series of cut solutions provided by invention depicted in FIG. 1;

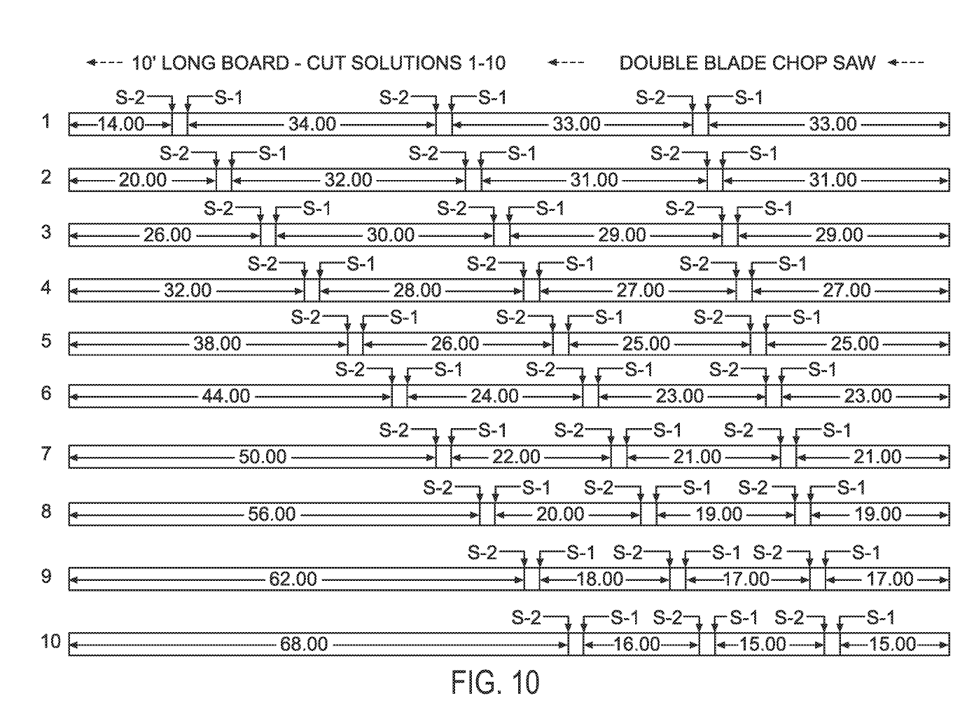

FIG. 11 is a side schematic view of another series of cut solutions provided by invention depicted in FIG. 1;

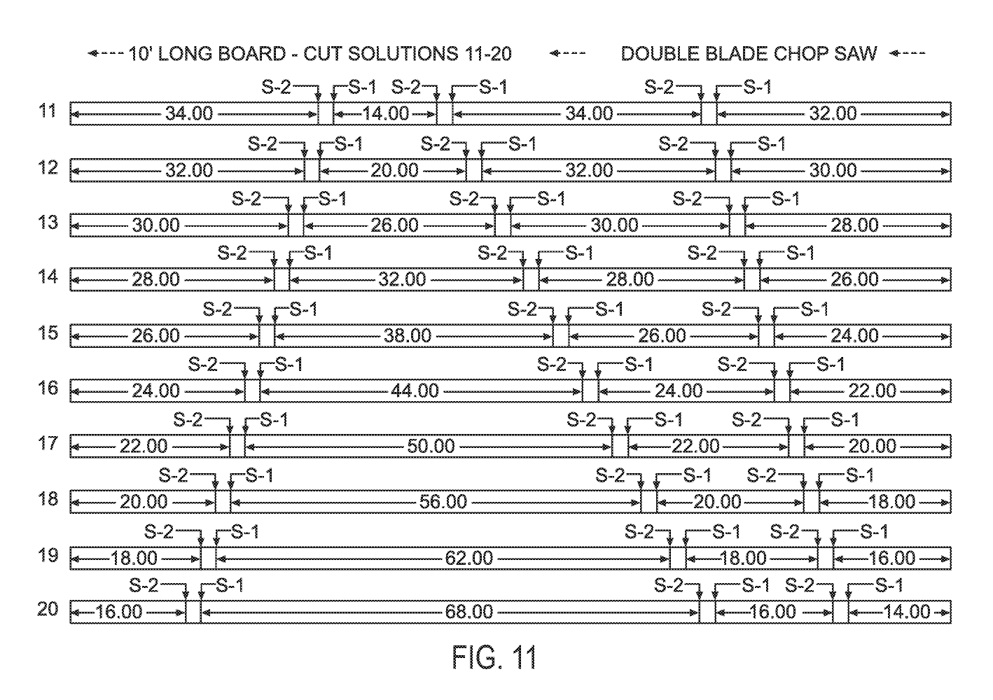

FIG. 12 is a side schematic view of end cut solutions for two boards provided by invention depicted in FIG. 1;

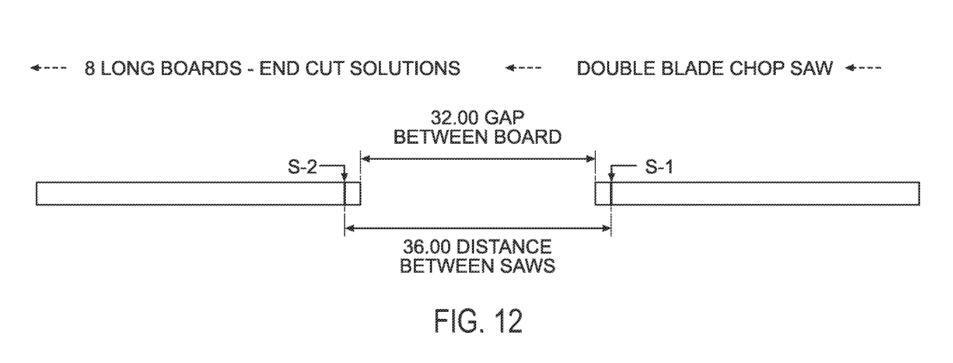

FIG. 13 is a bottom plan view of the invention depicted in FIG. 1;

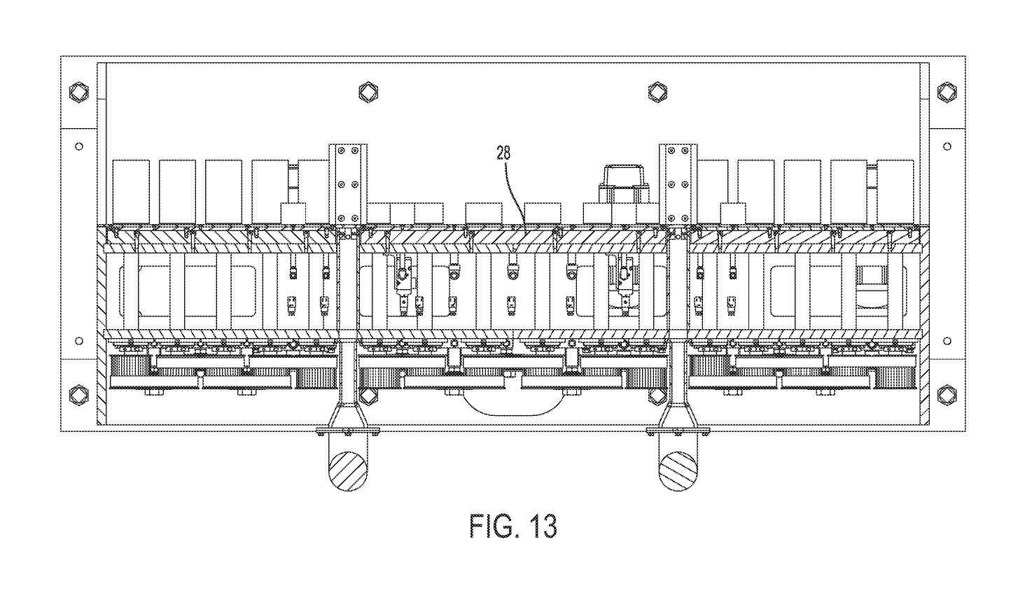

FIG. 14 is a top plan view of the invention depicted in FIG. 1;

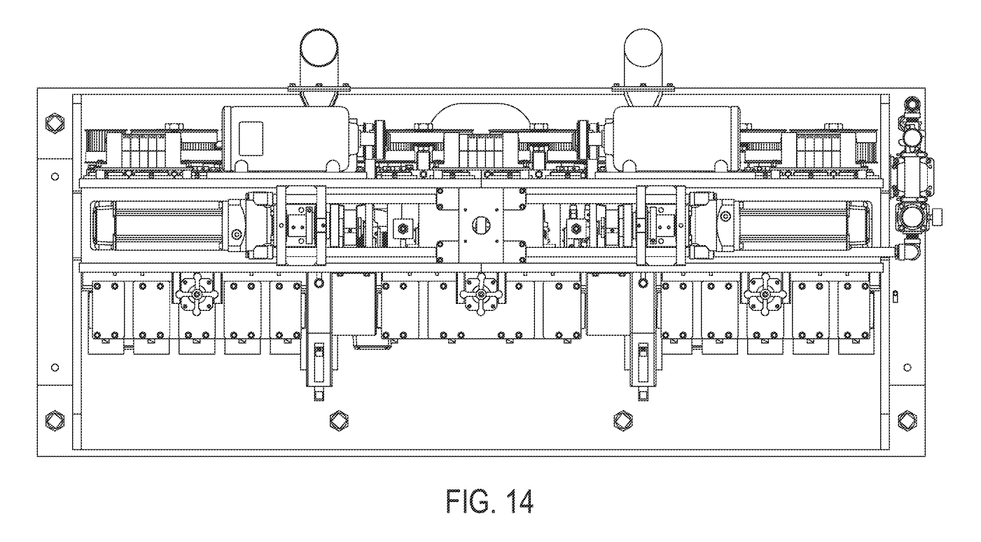

FIG. 15 is a rear cross-sectional view of the invention depicted in FIG. 1;

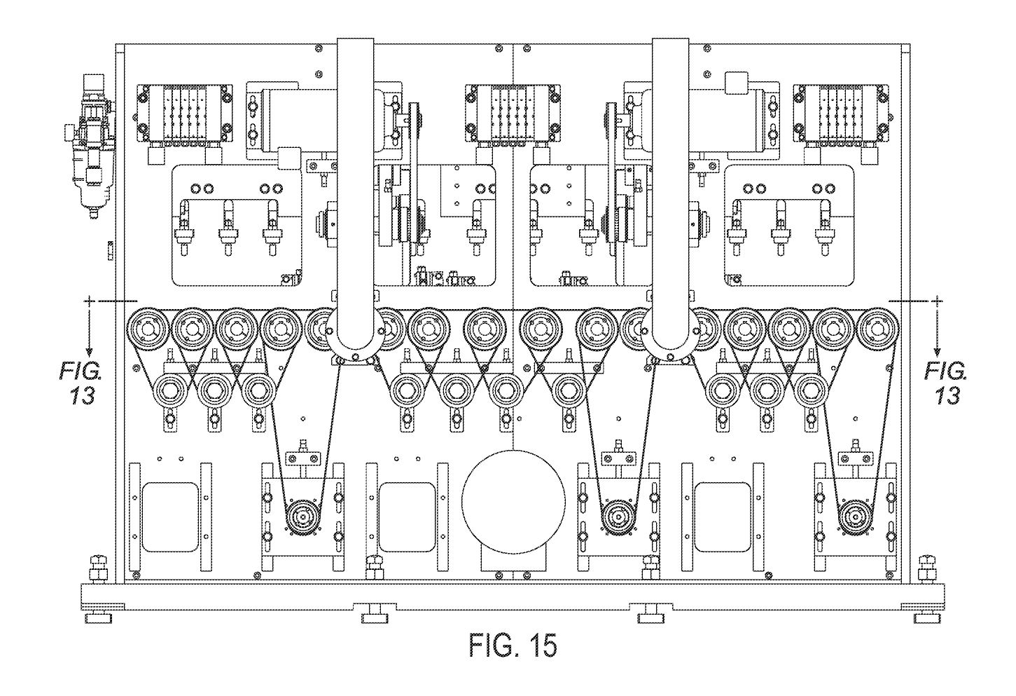

FIG. 16 is a front cross-sectional view of the invention depicted in FIG. 1; and

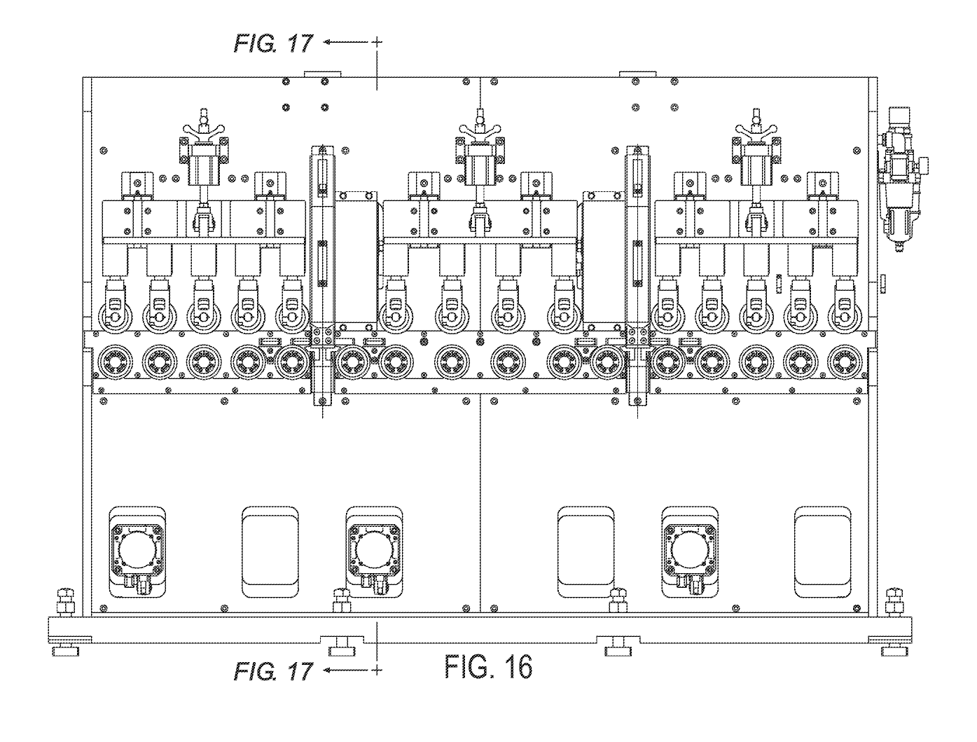

FIG. 17 is a side cross-sectional view of the invention depicted in FIG. 1.

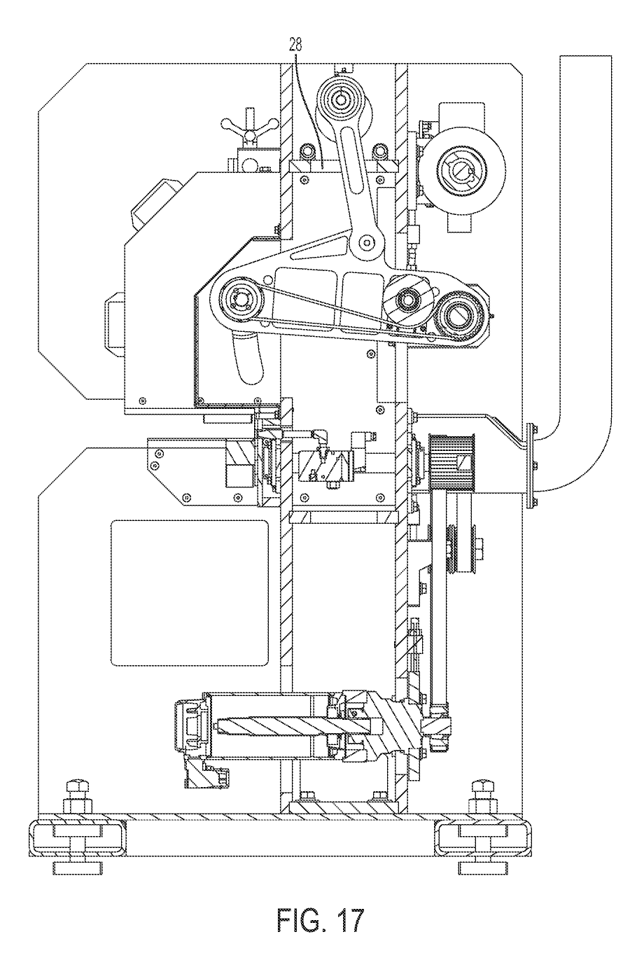

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The invention comprises in one embodiment a chop saw assembly 10 for cutting lumber comprising a housing 11 for receiving and dispensing lumber, a first and second chop saw assembly 12, 13 positioned within the housing for cutting identified defective lumber at desired locations, a plurality of conveyors 14 positioned within at least a portion of the housing for advancing lumber, and a plurality of motors 15 for operating the conveyors. The housing may include detectors for actuating an in-line advancement of lumber and a scanner for identifying proscribed defects in lumber.

Advantageously, the assembly detects proscribed defects in lumber, and the first and second chop saw assemblies operate independently and simultaneously to cut the defected areas of lumber from a piece of lumber and dispense the defected lumber piece from the housing. Further, the chop saw assembly can advance a first piece of lumber to a cut position at the second chop saw assembly while advancing a second piece of lumber to a cut point at the first chop saw assembly.

In another embodiment, the chop saw assembly includes a housing 11 defining an opening for receiving lumber 20, an opening for dispensing lumber 21, an opening for dispensing waste lumber 26, a plurality of conveyors 27 positioned within at least a portion of the housing for advancing lumber, and a plurality of feed rolls 22 for advancing lumber along the conveyors, wherein the feed rolls are operatively connected to the conveyors and secured within the housing. The housing defines an in feed section 24, a middle feed section 25, and an out feed section 30. The assembly also includes a plurality of hold-down rolls 23 for maintaining lumber on the conveyor wherein the hold-down rolls are positioned above the feed rolls. The assembly further includes a first chop saw assembly 12 substantially adjacent to the in feed section of the housing, wherein the first chop saw assembly is moveably secured to the housing. A second chop saw assembly 13 is provided that is substantially adjacent to the out feed section of the housing, wherein the second chop saw assembly is moveably secured to the housing.

The assembly further includes a plurality of motors for operating the conveyors and a support frame 28 contained within the housing for supporting the first and second chop saw assemblies, conveyors, and rolls. Beneficially, the assembly detects proscribed defects in lumber, and the first and second chop saws operate independently and simultaneously to cut the defected areas of lumber from a piece of lumber and dispense the defected lumber piece from the housing.

The plurality of conveyors includes an in feed conveyor 31 positioned in the in feed section of the housing, a middle conveyor 32 positioned in the middle feed section of the housing, and an exit conveyor 33 positioned in the out feed section of the housing.

The first chop saw assembly comprises a support 34 for maintaining a saw drive motor and a stroke motor 40, a support 41 for maintaining a blade spindle assembly 41 secured to the saw drive motor support, a blade stroke arm 43 secured to the saw drive motor support, and a saw blade 44 rotatably secured to the blade spindle assembly. Similarly, the second chop saw assembly comprises a support 45 for maintaining a saw drive motor 50 and stroke motor 51, a support 52 for maintaining a blade spindle assembly 53 secured to the saw drive motor support, a blade stroke arm 54 secured to the saw drive motor support, and a saw blade 55 rotatably secured to the blade spindle assembly.

The first chop saw assembly is positioned substantially between the in feed conveyor and the middle feed conveyor and delineates the in feed section and the middle feed section of the housing such that the first saw blade is moveable vertically between the in feed conveyor and the middle feed conveyor.

The second chop saw assembly is positioned substantially between the middle feed conveyor and the out feed conveyor and delineates the middle feed section and the out feed section of the housing such that the second saw blade is moveable vertically between the middle feed conveyor and the out feed conveyor.

The chop saw assembly may also provide a waste removal assembly 60 positioned in the middle feed section of the housing. The waste removal assembly includes a scanner 61 (e.g., machine vision system and software) for identifying proscribed defects in the lumber. The waste removal assembly may include air blast nozzles 62 for ejecting cut defective portions of lumber, a waste removal conveyor for moving the defective cut portions of lumber, and one or more waste chutes 63. The air blast nozzles are secured to the support frame and are positioned substantially between the plurality of hold down rolls and the plurality of feed rolls. The air blast nozzles advance defective cut lumber pieces laterally with respect to the longitudinal axis of the housing.

The assembly further includes a display 65 secured to an external portion of the housing. The display provides an operator interface and includes a touch screen that receives data regarding lumber within the housing from the scanner and determines a preferred cutting sequence for the first and second chop saw assemblies to execute. The operator interface (i.e., display) consists of a PC-based touch panel that receives board data from a scanner and determines the best cutting sequence for the saw to execute. The panel provides the following: basic operator functions (e.g., start/stop, etc.), saw set up parameters, diagnostics, status of drives and communications, control of feed table, control of lug chain to feed table, track scanned boards, statistics reporting, up time (e.g., system on or wood moving), down time (e.g., system stopped), average throughput (i.e., linear and square feet per minute, hour, and shift), raw wood in (square feet per minute, hour, and shift), good wood out (square feet per minute, hour, and shift), waste ejected (square feet per minute, hour and shift), and production history reports from date and time to date and time.

The plurality of feed rolls comprise a first set 70 operatively connected to the in feed conveyor, a second set 71 operatively connected to the middle feed conveyor, and a third set 72 operatively connected to the out feed conveyor.

The chop saw assembly also includes a sensor 73 (e.g., photoelectric cell) for detecting lumber entering the housing. This entrance sensor is positioned substantially adjacent to the in feed section of the housing, the sensor for activating the plurality of feed rolls and the plurality of hold down rolls. The assembly also includes a sensor 74 (e.g., photoelectric cell) for detecting lumber advanced to the in feed conveyor. This detection sensor is positioned within the in feed section.

The chop saw assembly further includes a plurality of actuators 75 (e.g., pneumatic actuators) that are operatively connected to the plurality of hold down rolls for vertically moving the hold down rolls (i.e., one each for each set of hold down rolls).

An air accumulator tank 80 is provided for containing air used to remove defected pieces of lumber via the air blast nozzles. Accordingly the air accumulator tank is in communication with the air blast nozzles.

The assembly may also include a plurality of chutes 81 for removing dust resulting from sawing the lumber. The chutes are in communication with an interior portion of the housing and an area external with respect to the housing.

The plurality of hold-down rolls comprise a first set 82 positioned within the in feed section of the housing, a second set 83 positioned within the middle feed section of the housing, and a third set 84 positioned within the out feed section of the housing.

The chop saw assembly also includes a number of motors for operating the device. The assembly includes a motor 85 for operating the first set of conveyors within the in feed section, a motor 90 for operating the second set of conveyors within the middle feed section, and a motor 91 for operating the third set of conveyors within the out feed section. The plurality of conveyors advance lumber linearly along a longitudinal axis of the housing.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A chop saw assembly for cutting lumber comprising:
a housing for receiving and dispensing lumber, said housing having detectors for actuating an in-line advancement of lumber;
a scanner for identifying proscribed defects in lumber;
a first and second chop saw assembly positioned within said housing for cutting identified defective lumber at desired locations;
a plurality of conveyors positioned within at least a portion of said housing for advancing lumber; and
a plurality of motors for operating said conveyors;
wherein said assembly detects proscribed defects in lumber, and said first and second chop saws operate independently and simultaneously to cut the defected areas of lumber from a piece of lumber and dispense the defected lumber piece from said housing.

2. A chop saw assembly according to claim 1 wherein said assembly advances a first piece of lumber to a cut position at said second chop saw assembly while advancing a second piece of lumber to a cut point at said first chop saw assembly.

3. A chop saw assembly for cutting lumber comprising:
a housing defining an opening for receiving lumber, an opening for dispensing lumber, and an opening for dispensing waste lumber, said housing having an in feed section, a middle feed section, and an out feed section;
a plurality of conveyors positioned within at least a portion of said housing for advancing lumber;
a plurality of feed rolls for advancing lumber along said conveyors, said feed rolls operatively connected to said conveyors and secured within said housing;
a plurality of hold-down rolls for maintaining lumber on said conveyor, said hold-down rolls positioned above said feed rolls;
a first chop saw assembly substantially adjacent to said in feed section of said housing, said first chop saw assembly moveably secured to said housing;
a second chop saw assembly substantially adjacent to said out feed section of said housing, said second chop saw assembly moveably secured to said housing;
a support frame contained within said housing for supporting said first and second chop saw assemblies; and
a plurality of motors for operating said conveyors;
wherein said assembly detects proscribed defects in lumber, and said first and second chop saws operate independently and simultaneously to cut the defected areas of lumber from a piece of lumber and dispense the defected lumber piece from said housing.

4. A chop saw assembly according to claim 3 wherein said first chop saw assembly comprises a support for maintaining a saw drive motor and a stroke motor, a support for maintaining a blade spindle assembly secured to said saw drive motor support, a blade stroke arm secured to said saw drive motor support, and a saw blade rotatably secured to said blade spindle assembly.

5. A chop saw assembly according to claim 3 wherein said second chop saw assembly comprises a support for maintaining a saw drive motor and stroke motor, a support for maintaining a blade spindle assembly secured to said saw drive motor support, a blade stroke arm secured to said saw drive motor support, and a saw blade rotatably secured to said blade spindle assembly.

6. A chop saw assembly according to claim 3 wherein said plurality of conveyors includes an in feed conveyor positioned in said in feed section of said housing, a middle conveyor positioned in said middle feed section of said housing, and an exit conveyor positioned in said out feed section of said housing.

7. A chop saw assembly according to claim 6 wherein said first chop saw assembly is positioned substantially between said in feed conveyor and said middle feed conveyor (and delineating said in feed section and said middle feed section of said housing) such that said first saw blade is moveable vertically between said in feed conveyor and said middle feed conveyor.

8. A chop saw assembly according to claim 3 wherein said second chop saw assembly is positioned substantially between said middle feed conveyor and said out feed conveyor (and delineating said middle feed section and said out feed section of said housing) such that said second saw blade is moveable vertically between said middle feed conveyor and said out feed conveyor.

9. A chop saw assembly according to claim 3 further comprising a waste removal assembly positioned in said middle feed section of said housing, said waste removal assembly having a scanner for identifying proscribed defects in the lumber, said waste removal assembly comprising air blast nozzles, a waste removal conveyor and waste chute, said air blast nozzles secured to said support frame and positioned substantially between said plurality of hold down rolls and said plurality of feed rolls.

10. A chop saw assembly according to claim 9 further comprising a display secured to an external portion of said housing, said display providing an operator interface, said display having a touch screen that receives data regarding lumber within said housing from said scanner and determines a preferred cutting sequence for said first and second chop saw assemblies to execute.

11. A chop saw assembly according to claim 9 wherein said air blast nozzles advance defective cut lumber pieces laterally with respect to the longitudinal axis of said housing.

12. A chop saw assembly according to claim 3 wherein said plurality of feed rolls comprise a first set operatively connected to said in feed conveyor, a second set operatively connected to said middle feed conveyor, and a third set operatively connected to said out feed conveyor.

13. A chop saw assembly according to claim 3 further comprising a sensor for detecting lumber entering said housing, said entrance sensor positioned substantially adjacent to said in feed section of said housing, said sensor for activating said plurality of feed rolls and said plurality of hold down rolls.

14. A chop saw assembly according to claim 3 further comprising a sensor for detecting lumber advanced to said in feed conveyor, said detection sensor positioned within said in feed section.

15. A chop saw assembly according to claim 3 further comprising a plurality of actuators operatively connected to said plurality of said hold down rolls for moving said hold down rolls (one each for each set of hold down rolls).

16. A chop saw assembly according to claim 3 further comprising an air accumulator tank for containing air used to remove defected pieces of lumber, said air accumulator tank in communication with said air blast nozzles.

17. A chop saw assembly according to claim 3 further comprising a plurality of chutes for removing dust resulting from sawing the lumber, said plurality of chutes in communication with an interior of said housing and an area external with respect to said housing.

18. A chop saw assembly according to claim 3 wherein said plurality of hold-down rolls comprise a first set positioned within said in feed section of said housing, a second set positioned within said middle feed section of said housing, and a third set positioned within said out feed section of said housing.

19. A chop saw assembly according to claim 3 further comprising:
a motor for operating said first set of conveyors within said in feed section, (belt)
a motor for operating said second set of conveyors within said middle feed section (belt)
a motor for operating said third set of conveyors within said out feed section (belt)

20. A chop saw assembly according to claim 3 wherein said plurality of conveyors advance lumber linearly along a longitudinal axis of said housing.
